(19) United States
(12) Patent Application Publication
(10) Pub. No.: US 2004/0216793 A1
(43) Pub. Date: Nov. 4, 2004

(54) Article for attachment to tire stem and lug nut stud

(76) Inventor: Michael D. Keller, Fort Wayne, IN (US)

Correspondence Address: RANDALL J. KNUTH P.C., 3510-A STELLHORN ROAD, FORT WAYNE, IN, 46815-4631, US

(21) Appl. No.: 10/700,397

(22) Filed: Nov. 3, 2003

Related U.S. Application Data
(60) Provisional application No. 60/466,495, filed on Apr. 29, 2003.

(51) Int. Cl. F16L 55/10

(52) U.S. Cl. 138/89.1; 138/89.3; 138/96 T

(57) ABSTRACT

Individual attachment devices are mounted to tire valve stems or wheel lug nut studs. An upper surface of the device serves as a display area for presenting display items such as promotional decals and logos. The device may also include tabs that project from the body of the attachment device. The tabs are used as display platforms that bear indicia on one of its surfaces, such as advertisements and marketing logos. A free-floating tab may be suspended away from the attachment device body by a connection means and likewise includes display items.

### CROSS-REFERENCE TO RELATED APPLICATIONS

This application claims the benefit of U.S. Provisional Patent Application No. 60/466,495 filed Apr. 29, 2003, hereby incorporated herein by reference thereto.

### BACKGROUND OF THE INVENTION

1. Field of the Invention

The present invention relates to vehicle tire and wheel attachments, and, more particularly, to a fixture or fitting device for coupling to valve tire stems and/or wheel lug nut studs.

2. Description of the Related Art

Sporting events such as auto racing generate significant marketing opportunities for advertisers and promoters since the vehicles themselves provide platforms for displaying commercial logos. However, with virtually every portion of the vehicle body now covered in some type of logo, there is a need to develop new marketing platforms to promote products in a manner that does not curtail or inhibit the current marketing schemes but rather supplements them.

### SUMMARY OF THE INVENTION

According to the present invention there is provided an attachment device or fitting that is attached to a tire valve stem. In one form, the fitting replaces the conventional dust cap and threads onto the upper threaded surface of the valve stem. The uppermost surface of the fitting that is distal from the attachment end of the valve serves as a display surface to present display items such as logos and advertisements. Alternately, a tab piece may be provided as an extension or projection from the main body of the device, such as in a cantilevering arrangement or formation. In this form, the display area corresponds to one surface of the projection tab.

In effect, the tab or other surface of the fitting that is adapted for use as an advertising platform serves as a miniature billboard.

Alternately, the fitting may be provided with a stem-receiving channel so that the fitting slides over the valve stem and is retained by the dust cap when screwed onto the valve stem in conventional manner. A similar projection tab is used as a display platform.

In another embodiment, an attachment device is mounted annularly about the stud of a wheel lug nut. The mounting process may be effectuated by a screw-on type engagement. A display tab is connected to the main body of the stud attachment device such that the display tab is provided in free-floating, cantilevering suspension away from the main body of the device. In one form, the tab is disposed axially forward of the lug nut.

In another embodiment, an attachment device includes a generally planar upper body joined to a cylindrical-shaped lower body. The lower body includes an axial receptacle space into which a fixed insert is placed during mounting installation. The upper surface of the upper body is recessed relative to a peripheral rim structure that circumscribes the surface. This upper surface bears indicia such as marketing logos and advertisements. The receptacle space preferably includes a threaded surface that complementarily mates with the threaded surface of the fixed insert, e.g., valve stem or lug nut stud. The receptacle space forms a bore or channel suitable to receive the corresponding fixed insert of the intended application environment.

In another embodiment, an attachment device or fitting includes a main support body. A receptacle space is formed in the support body and defines a mounting axis. The receptacle space is adapted to enable location of at least part of a fixed insert therein during operational mounting of the fitting to the insert. A tab extends from the fitting support body. In one form, the tab extends non-orthogonally relative to the mounting axis. In particular, the tab extends in a direction angularly offset from a direction orthogonal to the mounting axis. In different forms, the tab may be disposed or biased such that the tab in its normal state is positioned away from or towards the mounting platform (e.g., valve stem) that receives the fitting. For example, in profile, this bias appears as an angular deflection relative to the generally transverse plane of the support body. Additionally, the deflection may be towards or away from the application environment, e.g., vehicle wheel.

In various forms, the embodiments may be considered, without limitation, a coupling unit, an attachment device or mechanism, a fixture, a fitting, a mountable part, a flange, a hinged part, flap, tab, extension piece, projection-type element, or coupon.

In addition to display items pertaining to marketing, commercial or advertisement messages, it may also be possible for the projection tabs of the invention to bear any other indicia, including, but not limited to, personalized messages and non-commercial graphics, text, and/or images.

One advantage of the present invention is that the display tabs offer increased marketing opportunities in environments otherwise thought to be at full capacity in terms of available advertising space, such as the logo-bearing vehicles driven in the NASCAR racing circuit.

Another advantage of the present invention is that the attachment devices can be mounted to existing vehicle structures (e.g., valve stems and wheel lug nut studs), thereby avoiding any retrofitting of vehicles and making the invention readily practiced with any application environment.

Another advantage of the invention is that the attachment devices can seamlessly integrate with existing valve stems and lug nut studs, since the devices are formed to fit to such host platforms in an as-is fashion.

Another advantage of the invention is that the attachment devices are amenable to replacement in order to accommodate changes in the marketing schemes (e.g., advertisements on display), since the devices can be removed and replaced with no more difficulty than what it takes to change a valve stem cap, for example.

Another advantage of the invention is that the attachment devices offer the same functional features as the devices they replace, for example, a valve stem cap.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic perspective side view of a valve stem attachment device, according to one form of the invention;

FIG. 2 is a schematic upper view of the attachment device of FIG. 1;

FIG. 3 is a schematic perspective side view of a valve stem attachment device, according to another form of the invention;

FIG. 4 is a schematic upper view of the attachment device of FIG. 3;

FIG. 5 is a schematic perspective side view of a valve stem attachment device, according to another form of the invention;

FIG. 6 is a schematic upper view of the attachment device of FIG. 5;

FIG. 7 is a schematic perspective side view of the attachment device of FIG. 5 in a deployed installation configuration;

FIG. 8 is a schematic perspective side view of a lug nut attachment assembly as illustrated in a deployed installation configuration, according to another form of the invention;

FIG. 9 is a schematic axial perspective view of a wheel structure including an array of lug nut attachment assemblies as shown in FIG. 8;

FIGS. 10A-C respectively depict a fragmentary cut-away perspective view, an upper plan axial view, and a cross-sectional view of a display-type attachment device, according to another form of the invention;

FIGS. 11A-C respectively illustrate an upper plan view of a fitting device, a cross-sectional view taken along lines D-D′ of FIG. 11A, and an upper perspective view, according to another form of the invention;

FIG. 12A shows an upper plan view of the fitting of FIG. 11 as configured in an installed mounting position; and

FIG. 12B is an enlarged sectional view of the main support body of the fitting depicted in FIG. 12A showing the axial insertion of the valve stem.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

Referring now to the drawings and particularly to FIG. 1, there is shown an attachment device 10 having a generally solid body construction 12. Device 10 is shown in a deployed installation configuration in relationship to a conventional tire valve stem 8 having a threaded surface 9, shown in phantom.

Device 12 includes an upper end 14 and a lower end 16. Device 12 further includes an axial bore or open-ended channel 18 formed therein at the lower end 16 that defines a receptacle space for threadably receiving the threaded portion of valve stem 8. For this purpose, channel space 18 includes a threaded surface at its circumferential periphery that is complementary to threaded surface 9 of stem 8 to facilitate threading engagement therebetween.

Device 10 can have any of various construction designs, sizings, geometries, and shapes for body 12. Accordingly, the shape depicted in FIG. 1 should not be considered in limitation of the invention. In various forms, body 12 can have a frustoconical shape, a cone-type shape, a tapering or reduced diameter profile, or other suitable geometrical form. The invention should also be considered as encompassing irregular or regular geometries for the shape of body 12. Body 12 can also have any of various cross-sectional shapes, such as circular, oblong, elliptical, or any other form.

In one form, for example, body 12 will feature the indicated truncated conical shape having the maximal surface cross-section at upper end 14 to provide an area 20 for displaying images, such as advertisements or logos. Accordingly, following installation, device 10 is preferably oriented such that surface 20 faces generally outwardly from a vehicle in a manner that enables ready viewing by an observer standing near the vehicle.

During installation, device 10 is deployed in mounting relationship to valve stem 8 by a screw-on threading engagement between the threaded surface of stem-receiving channel 18 and the threaded surface 9 of valve stem 8. In this manner, device 10 remains secured to valve stem 8 by this threaded coupling. No modifications need be made to the valve stem 8 since the stem-receiving channel 18 of device 10 is adapted for compatible connection with the valve stem.

Device 10 can provide any number of functionalities. For example, in one form, device 10 can serve as a replacement dust cap to substitute for the screw-on cap typically mounted to tire valve stems. In this manner, due to its size and configuration relative to conventional dust caps, device 10 can provide improved stem protection, stability, and location retention. In alternate forms, attachment device 10 can be considered a coupling unit, fitting, or cover unit.

Notably, body 12 includes upper surface 20 that serves as a platform or display area on which any of various artworks, characters, logos, images, symbols, graphic forms, text, or any other tangible media may be mounted, disposed, or placed. It should be apparent that this list of display items is merely illustrative and should not be considered in limitation of the invention, as any form may be provided on display surface 20.

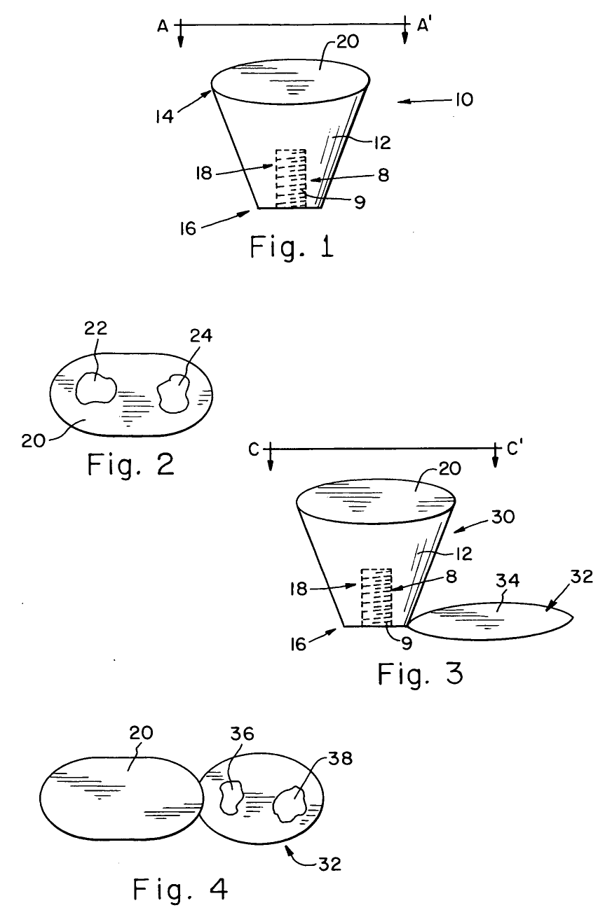

Additionally, the manner of fixing or placing such display items on display surface 20 is not limited but may include any conventional process. For example, display items may be disposed on surface 20 by printing, embedding, impregnation, or by any other means. Additionally, the display items can be permanently fixed on surface 20 or removably attached. FIG. 2 shows a top planar view of device 10 taken along lines A-A′ of FIG. 1, depicting illustrative observable display items 22 and 24 appearing thereon.

The benefit of display surface 20 of device 10 is that this area provides advertisers with additional promotional opportunities to mount advertisement logos and decals on a vehicle. For example, in heavily advertised sporting venues such as the NASCAR racing circuit, sponsor logos appear on virtually every surface of the vehicle. Display surface 20 can thereby provide additional “billboard” space at each valve stem of every tire to display promotional information. For example, decals with logos, car number, team name, sponsors, and other such information may appear on surface 20.

Referring now to FIG. 3, there is shown a device 30 similar to attachment device 10 of FIG. 1, but modified to include a projection piece 32 extending from body 12 at lower end 16, in accordance with another form of the invention. FIG. 4 shows a top planar view of device 30, taken along lines C-C′ of FIG. 3.

In alternate forms, projection piece 32 may be considered a tab, flap, wing, appendage, extension piece, tag, hinged element, or flag-type element. Additionally, projection piece 32 can have any of various forms. For example, piece 32 can have a generally planar solid body form having an upper surface 34. Piece 32 can be formed as a unitary structure with body 12 or formed as a discrete structure and attached to body 12 by any conventional means, e.g., hook or other retention mechanism.

Additionally, projection piece 32 can be rigidly attached to body 12 or can have a hinge-type attachment that enables flexing of projection piece 32 relative to body 12. The projection piece 32 itself can have a rigid construction or an elastic form, such as a hard weather-resistant rubber or elastomer material.

Referring back to FIGS. 1 and 2, the upper surface 20 of body 12 serves as the display area for receiving display items such as decals and logos. However, in FIGS. 3 and 4, this functionality is provided by projection tab 32. In particular, referring to FIG. 4, illustrative display items 36 and 38 are now disposed on projection tab 32 at its upper surface 34. This upper surface 34 faces generally outwardly away from the vehicle so as to be visible by an observer located apart from the vehicle. As an enhancement, it may still be possible to add decals or logos to upper surface 20, as in FIGS. 1 and 2.

In another feature, projection tab 32 can be adapted to be removably attached to body 12 of device 30, such that variations and changes in the display items can be readily effectuated by simply replacing projection tab 32 with another such tab having the desired display item(s). This manner of updating the display items may be more feasible and practicable than removing the current decal from the mounting surface or overlying it with another logo.

During installation, device 30 attaches to a corresponding valve stem in a manner similar to device 10 of FIG. 1. In particular, as with device 10, device 30 is formed with an open-ended axial channel 18 having a threaded surface that complementarily receives the threaded portion 9 of conventional valve stem 8.

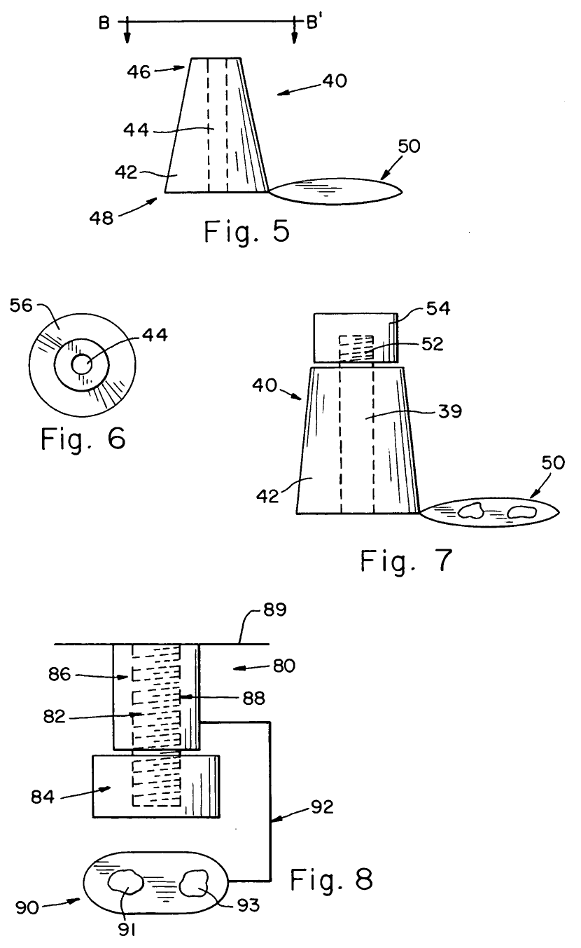

Referring now to FIG. 5, there is shown in lateral plan view an attachment device 40 for installation with a tire valve stem (not shown), according to another form of the invention. FIG. 6 shows a top planar view of device 40 taken along lines B-B′ of FIG. 5. FIG. 7 shows a perspective view of device 40 in a fully deployed installation configuration with tire valve stem 39 extending therethrough.

Referring to FIG. 5, device 40 includes an elongate body 42 having a generally annular cross-section. Body 42 further includes a bore or stem-receiving channel 44 formed completely therethrough and extending from one axial end to another. Body 42 has a form and cross-sectional shape similar to body 12 of device 10 in FIGS. 1 and 2.

However, as shown, device 40 may be installed in an orientation relative to the tire valve stem that is inverted in comparison to the relationship shown in FIG. 1. For example, in an exemplary reduced diameter profile, body 42 has an upper end 46 and a lower end 48, wherein the smaller-diameter upper end 46 is proximal the free end of the as-installed valve stem (not shown), while the larger-diameter lower end 48 is proximal the attached end of the valve stem, i.e., the valve-tire joint.

As shown, device 40 also includes a projection piece or tab 50 similar in structure and functionality to projection piece 32 of FIGS. 3 and 4.

During operation, as shown in FIG. 7, device 40 is deployed by sliding body 42 over conventional valve stem 39 such that valve stem 39 extends through channel 44. In this manner, the axial body of valve stem 39 guides and otherwise locates the positioning of device 40. Device 40 is sufficiently designed and constructed such that when it is fully installed, the threaded upper end 52 of valve stem 39 remains sufficiently exposed to enable the conventional dust cap 54 to be screwed thereon in known manner.

In one feature, referring to FIG. 6, the uppermost end of body 42 is defined by an annular axial surface 56 that is sized and dimensioned such that the as-installed dust cap 54 firmly seats upon and otherwise engages annular surface 56 to thereby securably retain device 40 in its installed position, preferably in fixed axial registration. In this form, for example, the periphery of installed dust cap 54 will lie intermediate the inner and outer radius of axial end surface 56. Alternately, the dust cap 54 and axial end surface 56 of device 40 need not continuously abut one another, but it would be sufficient for a minimal axial distance to separate these parts in order for the dust cap to maintain some degree of axial control over the location of device 40, e.g., minimize axial movement.

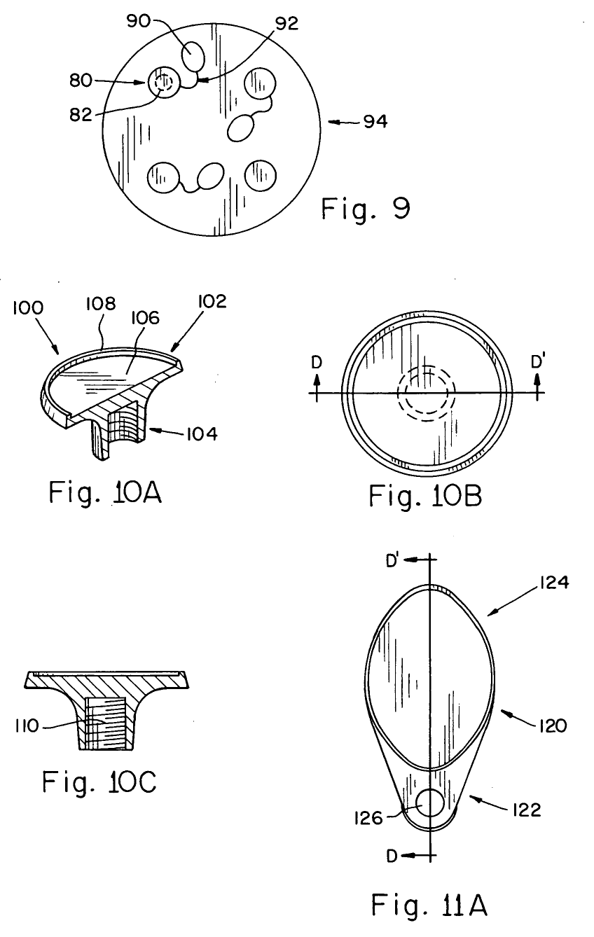

Referring now to FIG. 8, there is shown in upper plan view an attachment device 80 for use in connection with a conventional wheel apparatus having a bolt-type stud 82 and an associated wheel lug nut 84, according to another form of the invention.

The illustrated device 80 includes an elongate body portion 86 with a generally annular cross-section. Body 86 further includes a channel 88 formed therethrough to receive stud 82. Any construction or suitable structure can be used to form body 86, along with any suitable geometry or shape.

In one form, channel 88 has a threaded surface complementary to the conventional threaded surface of stud 82. Accordingly, during installation, device 80 is deployed by a screw-on-type threading engagement or connection between stud 82 and body 86 at channel 88. As shown, body 86 is mounted or otherwise disposed between wheel lug nut 84 and wheel surface 89.

Device 80 further includes a projection piece 90 similar in structure and functionality to tab 32 of FIGS. 3 and 4. For example, projection piece 90 includes illustrative display items 91 and 93. Device 80 includes a connection element or other suitable means for coupling projection piece 90 to body 86 of device 80. Any means may be used to facilitate such a connection. In one form, projection piece 90 is disposed in a free-floating suspended position axially forward of lug nut 84.

The combination of connection means 92 and projection piece 90 may be removably secured to body 86 as a unit, such that different promotional logos may be advertised by simply replacing this combination with a new one. Alternately, projection piece 90 may be removably secured to connection means 92, in order to facilitate updated advertising by simply replacing projection piece 90 with a new one.

FIG. 9 shows an exemplary arrangement of devices 80 configured at the various stud positions of a wheel apparatus 94. As shown, it is preferable to arrange the individual projection pieces 90 in a manner such that the associated display items 91 and 93 face outwardly away from the vehicle (or in any other preferred direction) to facilitate observation and viewing by the intended target audience, e.g., individuals standing near the car.

Referring now to FIGS. 10A-C, there is shown in FIG. 10A a fragmentary, cut-away, sectional perspective view of an attachment device 100, according to another form of the invention. FIG. 10B is an upper plan axial view of an assembled device constructed in accordance with the design arrangement of FIG. 10A. FIG. 10C is a cross-sectional view taken along lines D-D′ of FIG. 10B.

Referring to FIGS. 10A-C, device 100 includes an upper body 102 joined to a lower body 104, such as in a unitary construction. Upper body 102 defines a platform surface 106 circumscribed by a raised peripheral wall or rim 108. As shown, surface 106 is axially recessed relative to periphery 108. Platform surface 106 receives display items such as marketing or advertisement logos, in a manner and for a purpose similar to the attachment devices discussed above. Upper body 102 has a generally circular shape, although any geometrical formation may be used.

The illustrated lower body 104 has a generally elongate, annular cross-sectional form with a core or channel 110 formed therein to accommodate receipt of an insert piece (not shown) for purposes of attaining mounted operational installation of device 100, in a manner similar to the devices of FIGS. 1-4. For this purpose, channel 110 includes a threaded surface that is complementary to the threaded surface of the mounting insert, such that device 100 is firmly mounted in its installed position by a threaded connection. Generally, the threaded surface of channel 110 will be formed to be compatible with the corresponding threaded surface of the application environment, e.g., a conventional stud or valve stem.

The axial extent of lower body 104 and the depth of channel 100 will be suitable to accommodate proper receipt of the mounting insert (e.g., valve stem). As shown, the upper body 102 and lower body 104 may be joined together with a joint having a curved or concave-type form in profile. However, other surface contours are also possible for connecting or joining upper body 102 to lower body 104. Preferably, the entire assembly has a unitary construction.

In one form, it may be considered that the profile of device 100 generally resembles the seat end of an individual valve component in the valve train of a vehicle. In another form, it may be considered that upper body 102 defines a generally planar form, while the lower body 104 defines a generally annular form in cross-section, such as a cylindrical shape encompassing channel 110.

Device 100 may be used with any suitable insert. For example, device 100 may be formed for mounting to a conventional valve stem, such as with the devices shown in FIGS. 1-7.

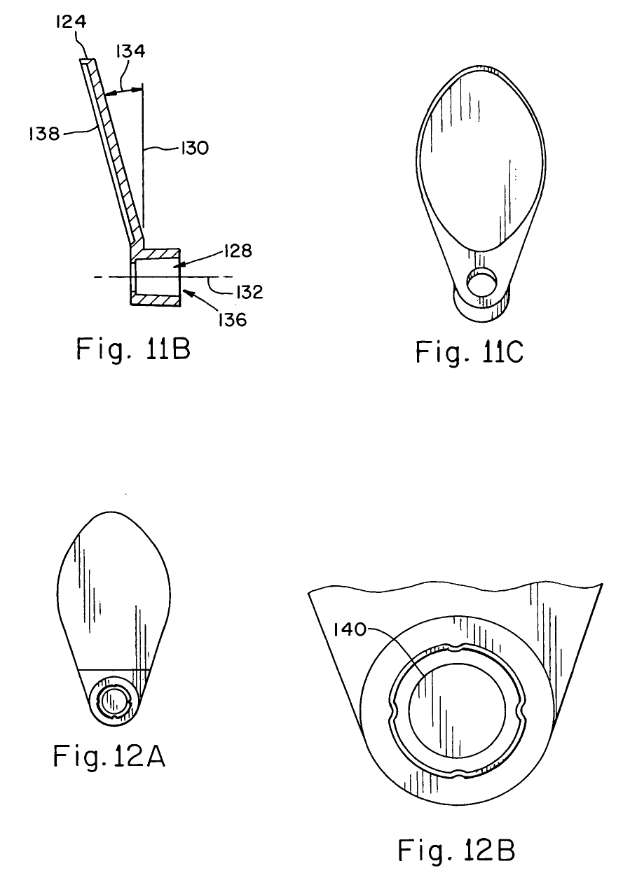

Referring now to FIGS. 11A-C, there are shown several view of a fitting or attachment device for mounting to a fixed insert such as a valve stem, according to another form of the invention. In particular, FIGS. 11A-C respectively depict an upper plan view, a cross-sectional view taken along lines D-D′ of FIG. 11A, and an upper perspective view. FIG. 12A shows an upper plan view of the fitting of FIG. 11 as configured in an installed mounting position. FIG. 12B is an enlarged sectional view of the main support body of the fitting showing the axial insertion of the fixed insert, e.g., valve stem.

Referring to FIGS. 11A-C, the illustrated fitting or attachment device 120 includes main support body 122 and a projection tab 124 extending from body 122. Support body 122 is provided with a bore or channel 126 formed therein. In alternate forms, the channel 126 may extend partially or fully through body 122. For example, in the cross-sectional view of FIG. 11B, channel 126 is formed fully through body 122 to define an axial passageway 128 that also generally defines a mounting axis, e.g., the axis of a valve stem that is fittingly received within receptacle passageway 128.

According to one feature of this embodiment, as shown especially in FIG. 11B, the tab 124 extends in a direction that is angularly offset from a transverse axis 130, which is generally orthogonal to the mounting axis 132 defining the axis of passageway 128. This angular offset is illustratively depicted at the angular span 134. As shown, passageway 128 generally possesses an annular form. Any suitable angular value may be used to establish the offset. Conventional manufacturing techniques well known to those skilled in the art may be used to fabricate and form fitting 120. Preferably, the fitting 120 has a unitary construction.

The tab itself defines a generally planar solid body. Tab 124 may be connected or joined to the main support body 122 at any axial location along body 122. Any shape or form may be used for tab 124. For example, the oblong or elliptical-type shape depicted in FIG. 11 should not be considered in limitation of the invention but merely illustrative thereof.

In different forms, the projection tab 124 may be oriented with its angular offset such that the tab is biased or disposed either forward or rearward of transverse axis 130 and/or its connection point to the main support body 122. For example, in FIG. 11B, tab 124 is disposed forward of transverse axis 130 in an axial direction generally away from the end of body 122 that receives the fixed insert, namely, end 136. In this manner, for example, tab 124 is disposed away from the mounting application environment, e.g., the valve stem of a vehicle tire.

Referring to FIGS. 12A-B, there is shown an axial end view of an illustrative insert (e.g., valve stem 140) that is received within passageway 128 of fitting 120 of FIG. 11, in accordance with a mounting installation of fitting 120. For purposes of connection, the surface of passageway 128 includes a threaded surface that mates in complementary fashion to the threaded surfaces of the insertable valve stem 140 to facilitate threaded locking engagement therebetween.

As with the projection tabs discussed previously in the other forms of the invention, the illustrated tab 124 of FIGS. 11-12 bears indicia (not shown) such as logos, marketing items, advertisements, commercial speech, and other displayable items. For example, in reference to FIG. 11B, the outer-directed surface 138 of tab 124 will bear such commercial indicia affixed thereto.

It should be understood that the mounting platforms for receiving the attachment devices disclosed herein should not be limited to tire valve stems and wheel lug nut studs. Rather, any suitable structure can receive the various attachment devices disclosed herein. For example, the invention may be practiced with any arrangement such as a post-type structure to which an element (i.e., attachment device) can be mounted by a sliding motion, threaded connection, or other type of coupling.

Additionally, even though the attachment devices discussed above are installed as discrete components in certain application environments, for example, where the conventional dust cap and lug nut can continue to be used, it is possible to adapt certain forms of the invention so as to incorporate certain features into the conventional parts or replace them. For example, the devices of FIGS. 1-4 can be mounted directly to valve stems so that once the full threaded connection is reached, the upper end of the attachment device overlying the exposed end of the valve stem effectively serves as a dust cap. Additionally, in FIG. 8, it may be possible to deploy the projection piece 90 and connection means 92 with conventional lug nut 84, so that the lug nut 84 now carries the advertisement items 91 and 93 (via projection piece 90 suspended therefrom).

As discussed herein, the attachment devices for engagement to tire valve stems and wheel lug nut studs may find utility in any type of application, such as motorized and non-motorized platforms. For example, the invention may be practiced with automobiles, SUVs, motorhomes, motorcycles, bicycles, trucks, racing vehicles, semis, and trailers.

Various materials may be used to construct the devices discussed herein. For example, without limitation, the devices may be fabricated from plastic, steel, die cast materials, injection molded materials, and rubber. Appropriate materials will be selected to endure the expected environmental conditions of the vehicle applications. The forms and shapes of the various attachment devices may also be tailored to various ergonomic factors, such as promotional, marketing and advertising appeal and attractiveness, particularly in the design and presentation of the logos and decals.

The individual attachment devices may be constructed according to any suitable geometric form to accommodate various aesthetic, installation, and operational considerations, for example. For example, the device bodies may be suitably formed to promote positional stability in the as-mounted position, particularly in vehicular applications where the attachment devices are subject to constant high-speed motion due to their coupling to tire valve stems and wheel lug nut studs.

Among the various figures, the indicated location of the projection pieces relative to the main body of the attachment device is merely illustrative and should not be considered in limitation of the invention. For example, in FIGS. 3 and 5, the respective projection tabs are disposed at a lower end of the respective device bodies. However, these display-type projection tabs can be placed along the length of the device body at any axial location, and also at any circumferential position. Moreover, multiple projection tabs may be attached to a single common body. Additionally, any size, shape or form may be used to construct the projection tabs.

The manner of securing the attachment devices or establishing the mounting relationship between the attachment devices of the invention and the corresponding inserts may use any suitable mechanism or process known to those skilled in the art. In particular, the threaded connections shown herein are illustrative and should not be considered in limitation of the invention. Other coupling technologies may be used, including, but not limited to, press fit connections, a retention mechanism (e.g., cap), and locking features. Preferably, the attachment devices are adapted to have features that mate with corresponding retention or interlocking features on the mounting insert, such as threaded surfaces or complementary male-female locking components.

It should also be apparent that the orientation of the extension tabs relative to the main support body may take on any of various suitable forms; accordingly, the disclosures shown in the drawings should not be considered in limitation of the invention but merely illustrative. For example, the tab may extend in a direction generally orthogonal to the principal axis of the main support body (e.g., mounting axis) from which the tab projects.

Alternately, the tabs may extend in a direction generally non-orthogonal to the principal axis of the main support body. For example, the tab may be disposed at a particular offset angle relative to the axis orthogonal to the mounting axis. Additionally, the direction of angular offset may be chosen so that the tab is disposed away from or towards the main support body. One consideration that could control the directivity and amount of angular orientation of the tab relative to the mounting axis concerns an interest in ensuring maximum or optimal visibility of the logos or display items affixed to the tab.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An article suitable for use with a tire stem having a threaded surface, said article comprising:
a fitting having a body with an upper end and a lower end; and
a recess formed in the fitting body at the lower end thereof, the recess having a threaded surface complementary to the threaded surface of the tire stem.

2. The article as recited in claim 1, wherein the fitting having a frustoconical shape.

3. The article as recited in claim 1, wherein the fitting having a tapered profile.

4. The article as recited in claim 1, wherein the fitting having a reduced diameter profile.

5. The article as recited in claim 4, wherein the reduced diameter profile progressing from the upper end to the lower end of the fitting body.

6. The article as recited in claim 1, wherein the article formed from one of polypropylene, polyethylene, plastic, and steel.

7. The article as recited in claim 1, wherein the fitting body having a cross-sectional shape including one of a circular form, an elliptical form, and an oblong form.

8. The article as recited in claim 1, wherein the upper end having a surface bearing indicia thereon.

9. The article as recited in claim 8, wherein the indicia including at least one of text, graphics, alphanumeric characters, artwork, advertisement, logo, and decal.

10. The article as recited in claim 1, further includes:
a projection piece extending from the fitting body.

11. The article as recited in claim 10, wherein the projection piece having a surface bearing indicia.

12. The article as recited in claim 11, wherein the indicia including at least one of text, graphics, alphanumeric characters, artwork, advertisement, logo, and decal.

13. The article as recited in claim 1, wherein the article being operatively deployable by threading engagement of the fitting to the tire stem.

14. An article suitable for use with a tire stem having a threaded surface, said article comprising:
a fitting having a body with an upper end and a lower end; and
a channel formed through the fitting body, the channel being suitable to operably receive at least a portion of the tire stem extending therethrough.

15. The article as recited in claim 14, wherein the fitting being suitably sized and/or dimensioned such that at least a portion of the tire stem threaded surface remains exposed concurrent with installation of the fitting relative to the tire stem.

16. The article as recited in claim 14, wherein the fitting having a reduced diameter profile.

17. The article as recited in claim 16, wherein the reduced diameter profile progressing from the lower end to the upper end of the fitting body.

18. The article as recited in claim 14, wherein the fitting body having an annular form.

19. The article as recited in claim 14, further includes:
a projection piece extending from the fitting body.

20. The article as recited in claim 19, wherein the projection piece extending from the lower end of the fitting body.

21. The article as recited in claim 20, wherein the projection piece having a surface bearing indicia.

22. The article as recited in claim 21, wherein the indicia including at least one of text, graphics, alphanumeric characters, artwork, advertisement, logo, and decal.

23. The article as recited in claim 14, wherein the upper end of the fitting body having an annular surface suitable to contactably confront a rim of a cap operably advancing along the tire stem during threading engagement of the cap with the tire stem threaded surface.

24. The article as recited in claim 14, wherein the article being operatively deployable by sliding advancement of the fitting over the tire stem.

25. An article suitable for use with a wheel lug nut stud having a threaded surface, said article comprising:
a fitting annularly disposed about at least a portion of the lug nut stud;
a projection tab; and
a means to connect the projection tab to the fitting.

26. The article as recited in claim 25, wherein the projection tab having a surface bearing indicia.

27. The article as recited in claim 26, wherein the indicia including at least one of text, graphics, alphanumeric characters, artwork, advertisement, logo, and decal.

28. The article as recited in claim 25, wherein the connection means including wire.

29. The article as recited in claim 25, wherein the connection means being one of rigid and flexible.

30. The article as recited in claim 25, wherein the connection means being adapted to position the projection tab generally in axial alignment with the lug nut stud.

31. An article suitable for use with a fixed insert, said article comprising:
a fixture having an upper body and a lower body joined together;
the fixture upper body having an upper surface axially recessed relative to a rim circumscribing the upper surface;
the lower body having a generally axial receptacle space formed therein, the receptacle space being adapted to enable location of at least part of the insert therein during operational mounting of the fixture to the insert.

32. The article as recited in claim 31, wherein the upper body and the lower body of said fixture having a unitary construction.

33. The article as recited in claim 31, wherein the upper surface of the fixture upper body bearing indicia.

34. The article as recited in claim 33, wherein the indicia including at least one of text, graphics, alphanumeric characters, artwork, advertisement, logo, and decal.

35. The article as recited in claim 31, wherein the receptacle space of the fixture lower body includes a threaded surface complementary to a threaded surface of the insert.

36. The article as recited in claim 31, wherein the fixture upper body defines a generally planar form, and the fixture lower body defines a generally annular form in cross-section.

37. An article suitable for use with a fixed insert, said article comprising:
a fitting having a support body;
a receptacle space formed in the support body and defining a mounting axis, the receptacle space being adapted to enable location of at least part of the insert therein during operational mounting of the fitting to the insert; and
a tab extending from the fitting support body, the tab extending non-orthogonally relative to the mounting axis.

38. The article as recited in claim 37, wherein the tab extending from the fitting support body at an end thereof opposite another end thereof operably receiving the insert.

39. The article as recited in claim 37, wherein the tab being disposed outwardly away from an end of the fitting support body operably receiving the insert.

40. The article as recited in claim 37, wherein the tab having a surface bearing indicia.

41. The article as recited in claim 40, wherein the indicia including at least one of text, graphics, alphanumeric characters, artwork, advertisement, logo, and decal.

42. The article as recited in claim 37, wherein the receptacle space extending at least partially through the fitting support body.

43. The article as recited in claim 37, wherein the receptacle space having a threaded surface complementary to a threaded surface of the insert.
